(19) United States
(12) Patent Application Publication
(10) Pub. No.: US 2013/0208249 A1
(43) Pub. Date: Aug. 15, 2013

(54) MEDICAL IMAGING APPARATUS

(71) Applicant: Ralph Kimmlingen, Zirndorf (DE)

(72) Inventor: Ralph Kimmlingen, Zirndorf (DE)

(21) Appl. No.: 13/682,794

(22) Filed: Nov. 21, 2012

(30) Foreign Application Priority Data
Nov. 29, 2011 (DE) 102011087265.5

(51) Int. Cl. G03B 21/14

(52) U.S. Cl. CPC G03B 21/14
USPC 353/30; 353/119

(57) ABSTRACT

A medical imaging apparatus includes a detector unit and a housing unit enclosing the detector unit. A cylindrical receiving region is provided for receiving a patient. The receiving region is enclosed in a cylindrical manner by the housing unit enclosing the detector unit. A projection unit is provided that has at least one projection surface unit, on which images of objects disposed outside the detector unit and the housing unit enclosing the detector unit are displayed to generate a virtual viewing window for an observer.

### CROSS REFERENCE TO RELATED APPLICATIONS

This application claims priority of German Patent Office application No. 102011087265.5 DE filed Nov. 29, 2012. All of the applications are incorporated by reference herein in their entirety.

### FIELD OF INVENTION

The illustrated embodiments relate to a medical imaging apparatus, in particular a magnetic resonance apparatus, having a detector unit, a housing unit enclosing the detector unit, a cylindrical receiving region to receive a patient, the receiving region being enclosed in a cylindrical manner by the housing unit enclosing the detector unit, and a projection unit.

### BACKGROUND OF INVENTION

To examine a patient using medical imaging, in particular using magnetic resonance, it is necessary for the patient to be positioned within a cylindrical receiving region of the magnetic resonance apparatus for the duration of the magnetic resonance examination. This cylindrical receiving region typically has a diameter of 70 cm. The patient is conveyed into this receiving region lying on a patient couch, it being possible for local magnet coils also to be disposed around the patient, restricting the space available for the patient within the receiving region further, so the patient may experience claustrophobic anxiety for the duration of the magnetic resonance examination. A further negative experience for the patient during the magnetic resonance examination is that the field of vision and/or angle of vision of the patient is severely restricted due to the positioning of the patient in the cylindrical receiving region.

To increase patient comfort during the medical imaging examination, the diameter of the receiving region has been enlarged to up to 70 cm. Also the field of vision of the patient can be enlarged at least to some degree, if the length of the receiving region and/or of the magnetic resonance apparatus is limited, for example to a maximum length of approx. 1.50 m.

It is also known, for magnetic resonance examinations in which a head coil is used for example, for at least one mirror to be disposed on said head coil, to extend the field of vision of the patient to outside the receiving region to some degree at least.

### SUMMARY OF INVENTION

It is desirable to provide a medical imaging apparatus, in which the visual range of a patient is extended to a region concealed by the detector unit. This is achieved by the features of the independent claims. Specific embodiments are described in the subclaims.

The illustrated embodiments are based on a medical imaging apparatus, in particular a magnetic resonance apparatus, having a detector unit, a housing unit enclosing the detector unit, a cylindrical receiving region to receive a patient, the receiving region being enclosed in a cylindrical manner by the housing unit enclosing the detector unit, and a projection unit.

It is proposed that the projection unit has at least one projection surface unit, on which images of objects disposed outside the detector unit and the housing unit enclosing the detector unit are displayed, to generate a virtual viewing window for an observer. This can extend the visual range of an observer, for example a patient, to a region concealed by the detector unit. The virtual viewing window may, for example, be generated on the projection surface unit as a result of the projection and/or displaying of regions and/or objects, which are in particular concealed by the detector unit. This allows a concealed field of vision and/or a concealed visual field of an observer, for example of patient, which is concealed by the detector unit, to be displayed by means of the projection surface unit within an unconcealed field of vision of the observer. The projection surface unit can be disposed for example within the receiving region, so that when a patient is disposed within the receiving region, the projection unit can produce an impression of seeing through the detector unit and housing unit. Also for a person, for example an operator of the medical imaging apparatus and/or someone looking after the patient, who is outside the receiving region, a region within the receiving region, for example a patient region within the receiving region, can be displayed on the projection surface unit outside the receiving region. This gives an observer the optical impression of being able to see through the medical imaging apparatus to some degree at least. Objects and/or regions outside the detector unit and outside the housing unit enclosing the detector unit here can include all objects and/or all regions outside the detector unit and the housing unit enclosing the detector unit, and in particular also objects and/or regions within the receiving region of the medical imaging apparatus.

It is further proposed that the projection surface unit has at least one projection surface element, which is enclosed at least partially by the housing unit enclosing the detector unit. This allows the projection surface unit to be disposed compactly within the medical imaging apparatus in a particularly economical manner, in particular without requiring additional space. The projection surface unit here can be formed by at least a part of a housing wall of the housing unit enclosing the receiving region and/or by a housing wall on a front face of the housing unit enclosing the detector unit and/or a wall of the housing unit enclosing the detector unit radially outwards.

A particularly clear and highly visible display and/or projection of images, for example individual static images and/or an image sequence, can be achieved if the projection surface unit has at least one projection surface element, which comprises a reflecting projection surface. The reflecting projection surface may, for example, be configured so that there is optimum coordination of a high degree of reflection, a biocompatible surface, as required for clinical examinations, and an economical embodiment of the reflecting projection surfaces. The reflecting projection surface can for example be formed by a lacquer coating on the housing unit, the lacquer coating having an advantageous reflection coefficient and therefore being sufficiently bright during a projection. The reflecting projection surface may, for example, be formed by a surface of the projection surface unit facing an observer. The reflection coefficient of the reflecting projection surface may, for example, be configured in such a manner that a projection can take place without additional illumination within the projection surface.

It is also proposed that the projection surface unit has at least one projection surface element, which is conically configured. This allows image reproduction to be achieved in particular within the receiving region, in that the conically configured projection surface allows particularly compact and space-saving image reproduction to be achieved within the receiving region. Also the angle of incidence for beaming image beams onto the projection surface element can be configured to be particularly flat, thereby preventing problems for the patient and/or interference with the image beam, for example by the patient. It is also possible with the conically configured projection surface element for the beam height of an image transmission element, for example a projector and/or beamer and/or a laser projector, to be kept particularly low, thereby avoiding any tendency to error due to interfering objects within the beam region. It is sometimes advantageous here for the conically configured projection surface element to be disposed within the receiving region, with an opening in the conically configured projection surface element facing the patient and/or an isocenter of the detector unit. The conically configured projection surface element can comprise a reflecting projection surface facing the observer, onto which image beams are beamed, said image beams being reflected in a manner that is visible for an observer, for example a patient. Conically configured projection surface elements can also be configured for a back wall projection, in which the image beams strike a face of the projection surface element facing away from an observer and can be displayed in a manner that is visible for the observer on the face of the projection surface element facing said observer.

It is further proposed that the projection surface unit has at least one projection surface element, which comprises a flat screen. The flat screen may comprise the projection surface, it being possible for the flat screen to comprise organic light-emitting diodes, in particular flexible, organic light-emitting diodes. A particularly flexible projection surface unit can be achieved, which can be tailored to the position of the patient and/or can be tailored to a geometry of the housing unit, for example to an embodiment of the receiving region. The projection surface unit can also be configured as a single piece with an image transmission unit, thereby not requiring additional costs and space.

If the projection surface unit has an at least partial strip-type lens coating, it is possible to achieve stereoscopic image reproduction for an observer, for example a patient and/or an operator of the medical imaging apparatus. Stereoscopic image reproduction allows a depth of sharpness to be produced in the images when viewed, so that when viewing a two-dimensional image the observer can have the optical impression of viewing a three-dimensional image.

In one embodiment, it is proposed that the projection unit has an image transmission unit, which is designed to project and/or transmit images onto the projection surface unit. The image transmission unit can be formed for example by an optical projector and/or a beamer and/or a laser projector and/or further image-transmitting units that appear expedient to the person skilled in the art.

If the image transmission unit is disposed at least partially outside the receiving region to display images within the receiving region, the space available to the patient within the receiving region can be particularly large and any restriction of the receiving region by the image transmission unit is avoided.

If the image transmission unit has at least one cylindrical lens element, an image may be projected onto the projection surface unit in a space-saving manner, being equalized in the process. The cylindrical lens element may focus or widen a light beam along a single axis, thereby allowing setting of an image size along said axis. It may be possible to tailor the image size for example to a position and/or field of vision of the patient and/or to an embodiment of the projection surface unit. Also the at least one cylindrical lens element can have a beam splitter function, so that simultaneous transmission of a number of separate images may be achieved by means of a single image transmission unit. The cylindrical lens element may be disposed after an outlet lens and/or outlet opening of the image transmission unit along a beam direction.

A particularly real and/or current display of objects and/or regions concealed by the detector unit on the projection surface unit can be achieved if the projection unit has at least one image recording unit. The image recording unit can comprise for example at least one video camera, which may, for example, capture and/or record a region, which is concealed by the detector unit in the field of vision and/or visual field of an observer, in particular of the patient positioned within the receiving region.

If the image recording unit has at least one image recording element, which comprises an optical wide-angle lens element, the number of image recording elements may be minimized while still achieving a large image region. In one embodiment, the optical wide-angle lens element is formed by a hypergon lens, the image recording unit here, for example, having three hypergon lenses, each covering an angle range and/or an angle of vision of approx. 135°, so that image information can be captured for almost an entire space. The image recording element may comprise, for example, a camera element, for example a video camera.

It is further proposed that the image recording unit is disposed at least partially on an outer face of the housing unit enclosing the detector unit, thereby allowing a particularly compact arrangement of the image recording unit on the medical imaging apparatus to be achieved. It is also possible in this manner to capture and display a region enclosing the detector unit following the field of vision and/or visual field of the patient. Alternatively or additionally the image recording unit can also be disposed at least partially within the receiving region, so that recordings can be made of the patient to be displayed on a projection surface unit disposed outside the receiving region and outside the detector unit.

In a further embodiment, it is proposed that the image recording unit has at least one beam splitter unit, allowing a stereoscopic image recording to be achieved. The image recording unit with the beam splitter unit may be used together with the projection unit with its strip-type lens coating, so that it is possible to achieve stereoscopic image reproduction for an observer as well as stereoscopic image recording.

In one embodiment, it is proposed that the projection unit has at least one digital data processing unit, which processes recordings from at least two image recording elements to produce a common projection image. This allows a number of segments of a large region to be captured using a number of image capturing elements and this number of segments then to be combined by the digital data processing unit to produce a single overall image for the observer. The digital data processing unit can also be used for particularly fast and in particular delay-free reproduction of the images.

The illustrated embodiments are also based on a method for projecting images of objects for a medical imaging apparatus, the objects being concealed by a detector unit of the medical imaging apparatus and a housing unit enclosing the detector unit along a viewing direction of an observer.

It is proposed that the image is projected on a face of the detector unit facing the observer and/or on a face of the housing unit enclosing the detector unit facing the observer. It is possible in this manner to extend the visual range of an observer, for example of a patient, to a region concealed by the detector unit. Also the medical imaging apparatus can thus have a virtual viewing window at least to some degree, the virtual viewing window being generated by projecting and/or displaying regions and/or objects, which are concealed in particular by the detector unit, on the projection surface unit. This can give the observer, for example the patient and/or a further person, the optical impression of being able to see through the medical imaging apparatus, at least to some degree.

It is also proposed that the image is displayed on the projection surface unit with little delay. This allows a live transmission of images on the projection surface unit to be achieved. It also allows visual contact and/or optical communication to be established between the patient and a person looking after said patient. As an alternative or in addition to the visual contact or optical communication, acoustic communication can also be established between the patient and the person looking after said patient. It also allows a patient not to feel enclosed within the receiving region, at least to some degree.

It is also proposed that a sequence of a number of images is displayed at a speed of at least 25 images per second on a projection surface unit. This allows the individual images to be displayed to the observer, in particular to the patient, in the form of a film, thereby suggesting transparency of the medical imaging apparatus to the observer.

If image calibration is performed before a display on a projection surface, equalization parameters may be calculated for a display on a projection surface unit disposed within the receiving region, thereby allowing a distortion-free display on a cylindrical housing wall.

### BRIEF DESCRIPTION OF THE DRAWINGS

Further advantages, features and details will emerge from the exemplary embodiments described below and from the drawings, in which:

FIG. 1 shows a schematic diagram of a medical imaging apparatus,

FIG. 2 shows the medical imaging apparatus with a first embodiment of a projection unit,

FIG. 3 shows an image recording unit of the projection unit from FIG. 2,

FIG. 4 shows a projection surface of the projection unit from FIG. 2,

FIG. 5 shows a second embodiment of the projection unit with a flat screen,

FIG. 6 shows a third embodiment of the projection unit with a conically configured projection surface and

FIG. 7 shows a fourth embodiment of the projection unit with an image transmission unit having a beam splitter.

### DETAILED DESCRIPTION OF INVENTION

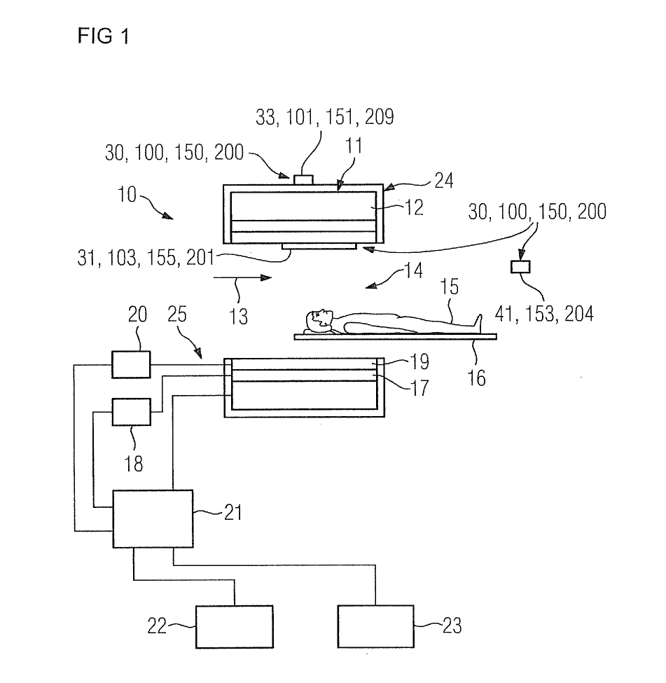

FIG. 1 shows a medical imaging apparatus 10, which is formed by way of example by a magnetic resonance apparatus. Alternatively the medical imaging apparatus 10 can also be formed by a computed tomography apparatus and/or a PET apparatus, etc.

The magnetic resonance apparatus comprises a detector unit formed by a magnet unit 11, having a main magnet 12 to generate a powerful and in particular constant main magnetic field 13. The magnetic resonance apparatus also has a cylindrical receiving region 14 to receive a patient 15, the receiving region 14 being enclosed in a cylindrical manner in a circumferential direction by a housing unit 24 of the magnetic resonance apparatus enclosing the magnet unit 11. The patient 15 can be conveyed into the receiving region 14 by means of a patient couch 16 of the magnetic resonance apparatus. The patient couch 16 is disposed in a movable manner within the magnetic resonance apparatus for this purpose.

The magnet unit 11 also has a gradient coil 17 for generating magnetic field gradients used for spatial encoding during imaging. The gradient coil 17 is controlled by means of a gradient control unit 18. The magnet unit 11 further comprises a high-frequency antenna unit 25, which has a high-frequency antenna 19 and a high-frequency antenna control unit 20, to excite a polarization in the main magnetic field 13 generated by the main magnet 12. The high-frequency antenna 19 is controlled by the high-frequency antenna control unit 20 and radiates high-frequency magnetic resonance sequences into an examination space, which is formed essentially by the receiving region 14. This deflects magnetization from its equilibrium position. Magnetic resonance signals are also received by means of the high-frequency antenna unit 25.

To control the main magnet 12, the gradient control unit 18 and to control the high-frequency antenna control unit 20 the magnetic resonance apparatus has a control unit 21 formed by a computation unit. The control unit 21 controls the magnetic resonance apparatus centrally, for example the performance of a predetermined imaging gradient echo sequence. The control unit 21 also comprises an evaluation unit for evaluating image data. Control information, such as imaging parameters for example, and reconstructed magnetic resonance images can be displayed on a display unit 22, for example on at least one monitor, of the magnetic resonance apparatus for an operator of the magnetic resonance apparatus. The magnetic resonance apparatus also has an input unit 23, which can be used by an operator to input information and/or parameters during a measuring process.

The illustrated magnetic resonance apparatus can of course comprise further components, which magnetic resonance apparatuses have as standard. A general mode of operation of a magnetic resonance apparatus is also known to the person skilled in the art, so there is no need for a detailed description of the general components here.

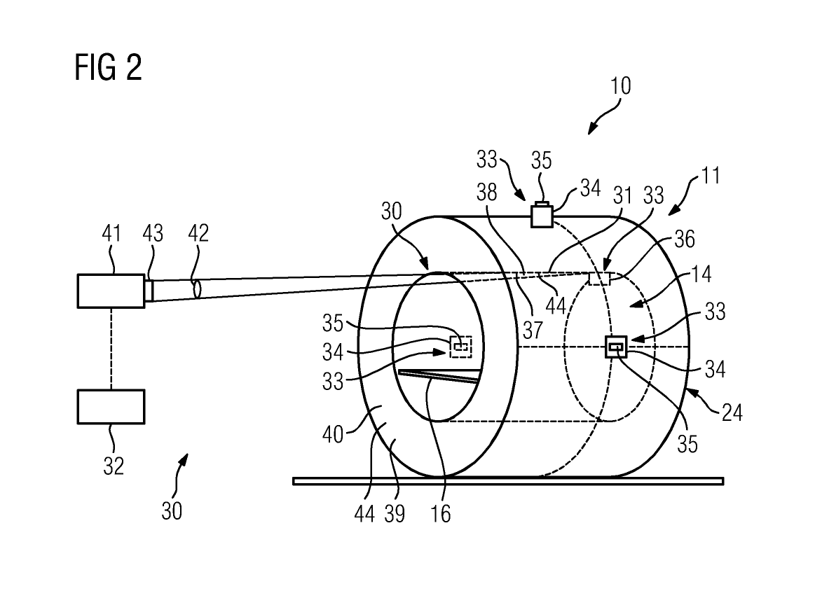

The magnetic resonance apparatus further comprises a projection unit 30, 100, 150, 200, which is shown in greater detail in FIGS. 2 to 7. FIGS. 2 to 4 show a first exemplary embodiment of the projection unit 30.

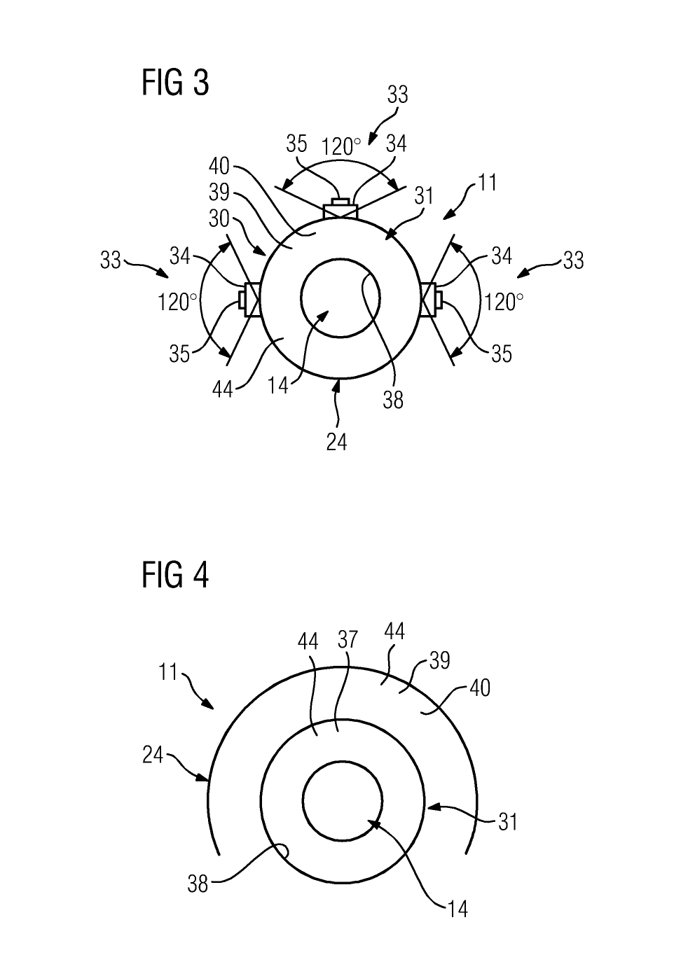

The projection unit 30 comprises a projection surface unit 31, a digital data processing unit 32 and an image recording unit 33. In the present exemplary embodiment the image recording unit 33 has three image recording elements 34, which are disposed around the magnet unit 11 in its circumferential direction on a face of the housing unit 24 enclosing the magnet unit 11 facing outwards in a radial direction. The individual image recording elements 34 here are each formed by a video camera, each of which comprises an optical wide-angle lens element 35, formed in the present exemplary embodiment in each instance by a hypergon lens. Each of the image recording elements 34 with a hypergon lens covers an angle range and/or an angle of vision of approx. 120° (FIG. 3), so that an entire visual range of the patient 14 concealed by the magnet unit 11 and the housing unit 24 enclosing the magnet unit 11 is captured by means of the three image recording elements 34 from a viewing direction of a patient positioned on the patient couch. The angle range covered by the hypergon lenses extends away from the magnet unit 11 here. The image recording elements 34 also have a beam splitter unit (not shown in detail), so that stereoscopic recordings can be produced using the image recording elements 34.

The image recording unit 33 also has a further image recording element 36, which is disposed within the receiving region 14 on the housing unit 24 enclosing the magnet unit 11. This image recording element 36 is used to record images within the receiving region 14 and display them for a person outside the magnetic resonance apparatus, for example a clinician operating the magnetic resonance apparatus and/or a relative of the patient 15.

The individual images recorded by the individual video cameras are routed by way of a data line (not shown in detail) to the digital data processing unit 32, where they are further processed, the digital data processing unit 32 having corresponding software and computer programs for this purpose. The digital data capturing unit 32 uses the individual images from the three video cameras, which were captured at the same recording time and/or for the same recording period using the three video cameras, to determine or calculate a common projection image. A conversion and/or transformation, in particular a coordinate transformation, of the individual images or of the projection image to cylinder coordinates for displaying the projection image within the receiving region 14 also takes place in the digital data processing unit 32.

For the conversion to cylinder coordinates the digital data processing unit 32 accesses calibration data, which is stored in a storage unit (not shown in detail) of the digital data processing unit 32. The calibration data includes a geometry of the magnetic resonance device, for example dimensions of the housing unit 24 enclosing the receiving region 14 and/or a position of the individual image recording elements 34 on the housing unit 24, etc. A position, for example a visual field, of the patient relative to a projection surface 37 of the projection unit 31 is also taken into account for the coordinate transformation. These parameters are used in the digital data processing unit 32 to convert the coordinates, so that a distortion-free display on a curved projection surface 37 formed by a lateral surface of the cylinder is possible for the patient 15 within the receiving region 14. Calibration can also take place in a reverse direction, if for example recordings are made of a region within the receiving region 14 and these recordings are displayed on a projection surface 37 of the housing unit 24 outside the receiving region 14, in particular on a front face of the magnet unit 11 and the housing unit 24 enclosing the magnet unit 11.

Alternatively the calibration can also take place using equipment, in that for example an image recording element 34 is positioned at a patient position within the receiving regions 14 and a visual field of the patient 15 is captured with a projection surface 37. The captured data can be used to determine how for example a straight line is captured within a curved projection surface 37, with conversion factors and/or transformation factors for a coordinate transformation being determined from this.

The projection surface unit 31 of the projection unit 30 is designed to display images. In FIGS. 2 to 4 the projection surface unit 31 has a projection surface element 38, which is encompassed by the housing unit 24 enclosing the magnet unit 11 or is formed by a part of a wall of the housing unit 24. To this end the projection surface element 38 is integrated or laminated within the housing unit 24 enclosing the receiving region 14, in particular in a face of the housing unit 24, which is in the shape of the lateral face of the cylinder and faces the receiving region 14, the projection surface unit 31 having a reflecting projection surface 37. The reflecting projection surface 37 here is embodied in such a manner that there is sufficient brightness at the projection surface 37 for images to be displayed. The projection surface 37 also has a strip-type lens coating, so that when images are being displayed the effect of three-dimensional images is produced for the observer when looking at two-dimensional images. Alternatively provision can also be made for the observer, for example the patient 15, to have a viewing aid, for example glasses, which give the observer an impression of a three-dimensional image when viewing a two-dimensional image.

The projection surface unit 31 also has a further projection surface element 39, which is disposed on an end face 40, in particular a front face, of the housing unit 24 enclosing the magnet unit 11. This further projection surface element 39 is integrated or laminated within the housing unit 24 and is provided for images recorded within the receiving region 14 using the image recording element 36.

The projection unit 30 also has a first image transmission unit 41, which comprises an optical projector and/or a beamer and/or a laser projector. The first image transmission unit 41 is used to transmit images captured using the image recording elements 34 to the projection surface element 38. The first image transmission unit 41 is disposed outside the receiving region 14, with the first image transmission unit 41 being disposed in such a manner that an image beam 42 along a beam direction from the first image transmission unit 41 to the projection surface element 38 takes up as little of the edge region as possible within the receiving region 14, so that unwanted interference with the image transmission by further objects that can project into the image beam 42 is prevented. The first image transmission unit 41 also has a cylindrical lens element 43. The cylindrical lens element can be used to set a beam height of the image beam 42, so that it can be tailored precisely to the dimensions of the projection surface element 38 within the receiving region 14. For the purposes of displaying on the further projection surface element the projection unit 30 has an image transmission unit (not shown in detail), which is also formed by a beamer and/or optical projector and/or a laser projector.

The projection unit 30 is used to display images of objects and/or regions, which are concealed by the magnet unit 11 and the housing unit 24 enclosing the magnet unit 11 along a viewing direction of an observer, on the projection surface elements 38, 39 disposed on the face of the housing unit 24 facing the observer. This generates a virtual viewing window 44 for the observer on the housing unit 24 enclosing the magnet unit 11 by means of the projection surface elements 38, 39. The display of the objects and/or regions concealed by the magnet unit 11 and the housing unit 24 enclosing the magnet unit 11 has little delay, so there can be an essentially direct transmission and/or live transmission of the objects and/or regions concealed by the magnet unit 11 and the housing unit 24 enclosing the magnet unit 11 to the projection surface unit 31. Image reproduction also takes place at a frequency of at least 25 images per second, so that a continuous film is generated for the observer, showing events taking place in regions concealed by the magnet unit 11 and the housing unit 24 enclosing the magnet unit 11. In one embodiment, the image reproduction may take place at a frequency of approx. 50 images per second to approx. 100 images per second.

FIGS. 5 to 7 show alternative exemplary embodiments of the projection unit 30, 100, 150, 200. Essentially identical components, features and functions are in principle shown in identical reference characters. The description which follows is restricted essentially to the differences compared with the exemplary embodiment in FIGS. 2 to 4, with reference being made to the description of the exemplary embodiment in FIGS. 2 to 4 in respect of identical components, features and functions.

FIG. 5 shows an alternative projection unit 100 to the one in FIGS. 2 to 4. The projection unit 100 comprises an image recording unit 101, which has an image recording element 102. Alternatively the image recording unit 101 can also comprise a number of image recording elements 102 as in the description relating to FIGS. 2 to 4. The image recording element 102 is formed by a video camera, which is disposed on a housing unit 24 enclosing the magnet unit 11, the housing unit 24 encompassing a face of the magnet unit 11 facing away from the receiving region 14. The image recording element 102 is configured in the same manner as the image recording elements in FIGS. 2 to 4.

The projection unit 100 also has a projection surface unit 103 with a projection surface element 104, which comprises a flat screen. The flat screen may, for example, be formed by a flexible flat screen, which at least partially comprises organic light-emitting diodes (OLED). The configuration of the flat screen as a flexible flat screen means that it is disposed on a wall of the housing unit 24 in a particularly space-saving manner within the receiving region 14. Provision can also be made for the projection surface unit 103 to have a number of projection surface elements 104, each of which can be formed by a flexible flat screen. The flat screen is bonded to the housing unit 24. In principle further means of fastening the flat screen to the housing unit 24, which appear useful to the person skilled in the art, are always possible.

The projection unit 100 further comprises an image transmission unit, which in the present exemplary embodiment is configured at least partially as a single piece with a digital data processing unit 105 of the projection unit 100. The digital data processing unit 105 here evaluates image data recorded and/or captured by the image recording element 102 and/or further processes such image data, it being possible also for a coordinate transformation to take place here as in the description relating to FIGS. 2 to 4. The evaluated and/or further processed image data is then routed to the flat screen and displayed there in a visible manner for the patient 15, so that a virtual viewing window 106 is generated for said patient 15.

A further embodiment and/or mode of operation of the projection unit 100 is/are configured as in the description relating to the exemplary embodiment in FIGS. 2 to 4.

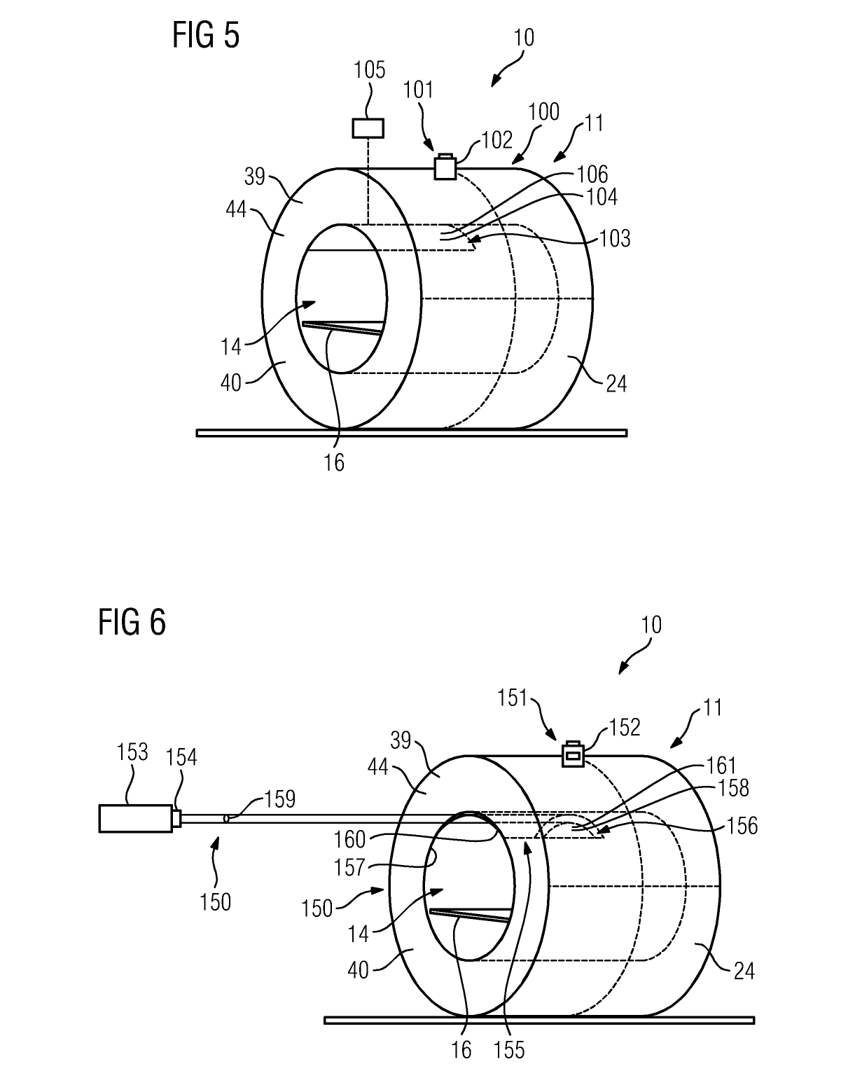

FIG. 6 shows an alternative projection unit 150 to FIGS. 2 to 5. The projection unit 150 comprises an image recording unit 151, which has an image recording element 152. Alternatively the image recording unit 151 can also comprise a number of image recording elements 152 as in the description relating to FIGS. 2 to 4. The image recording element 152 is formed by a video camera, which is disposed on a housing unit 24 enclosing the magnet unit 11, the housing unit 24 encompassing a face of the magnet unit 11 facing away from the receiving region 14. The image recording element 152 is configured in the same manner as the image recording elements in FIGS. 2 to 4.

The projection unit 150 also has an image transmission unit 153 as described in relation to the exemplary embodiment in FIGS. 2 to 4. The image transmission unit 153 is formed by a projector and/or a beamer and/or a laser projector and is provided with a cylindrical lens element 154, the cylindrical lens element 154 being provided for example to set an image size.

A projection surface unit 155 of the projection unit 150 has a projection surface element 156, which is formed by a conically configured projection surface element 156. An opening in the conically configured surface element 156 is disposed on a face of the conically configured projection surface element 156 facing a support region for the patient 15 and/or facing the patient couch 16 or an isocenter. The conically configured projection surface element 156 is also disposed on the housing unit 24 within the receiving region 14 in such a manner that a part 157 of the conically configured projection surface element 156 is disposed with a first radius on a face of the conically configured projection surface element 156 facing the image transmission unit 153. The first radius corresponds essentially to a radius of the receiving region 14. A second part 158 of the conically configured projection surface element 156 has a second radius, which is larger than the first radius and which is larger than the radius of the receiving region 14, the second part 158 being disposed on a face of the conically configured projection surface element 156 facing away from the image transmission unit 153. A transition between the first part 157 with the first, small radius and the second part 158 with the second, large radius is configured as continuous here.

Because of its geometrical configuration on the face facing the image transmission unit 153 the conically configured projection surface element 156 rests against the housing unit 24 enclosing the receiving region 14 in a cylindrical manner along its entire circumference with the face facing the housing unit 24. On the face facing away from the image transmission unit 153 the conically configured projection surface element 156 only rests against the housing unit 24 with peripheral regions due to the larger radius. The part 158 of the conically configured projection surface element 156 facing away from the image transmission unit 153 is therefore at a distance from the housing unit 24 at a center. The conically configured projection surface element 156 is bonded to the housing unit 24 at contact surfaces.

An image beam of the image transmission unit 153 is aligned in such a manner that a lower edge region of an image region 159 of the image transmission unit 153 strikes the part 158 of the conically configured projection surface element 156 facing away from the image transmission unit 153 and an upper edge region of the image region 159 strikes the part 157 of the conically configured projection surface element 156 facing the image transmission unit 153. The image beam here strikes the conically configured projection surface element 156 on a projection surface 160 facing the receiving region 14 or the patient couch 16, the image beams being reflected off the projection surface 160 of the conically configured projection surface element 156 for this purpose. A beam height of the image transmission unit 153 is configured here so that it can be set by an operator of the projection unit 150, so that the beam height can always be tailored to different conditions. The beam height is set using the cylindrical lens element 154. The image transmission unit 153 and the projection surface element 156 are used to generate a virtual viewing window 161 for an observer, in particular the patient 15.

A further embodiment and/or mode of operation of the projection unit 150 is configured as in the description relating to the exemplary embodiment in FIGS. 2 to 4.

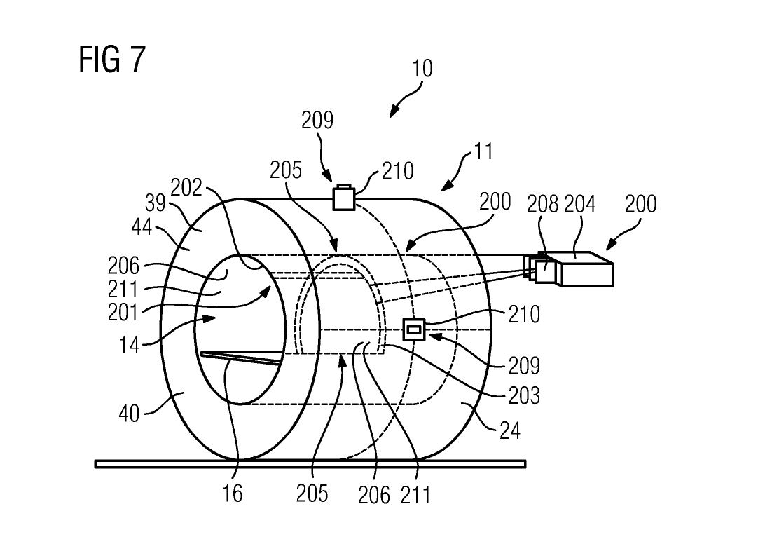

FIG. 7 shows an alternative projection unit 200 to FIGS. 2 to 6. The projection unit 200 differs from the projection unit 150 from FIG. 6 in the embodiment of a projection surface unit 201. The projection surface unit 201 has two conically configured projection surface elements 202, 203, each of which is configured as in the description relating to FIG. 6. The projection surface unit 201 can also have more than two or just one projection surface element 202, 203.

An image transmission unit 204 of the projection unit 150 is disposed on a face of the magnetic resonance apparatus facing away from an opening of the receiving region 14, so that a part 205 of the conically configured projection surface elements 202, 203 with the largest radius is disposed in each instance on a face of the conically configured projection surface elements 202, 203 facing the image transmission unit 204. Projection onto the conically configured projection surface elements 202, 203 by means of the image transmission unit 204 takes place here on a surface facing the housing unit 24 or a surface of the conically configured projection surface elements 202, 203 facing away from the patient region. To this end the conically configured projection surface elements 202, 203 are configured in such a manner that a back wall projection takes place on the conically configured projection surface elements 202, 203 and an image and/or projection is visible to the patient 15 on a projection surface 206 disposed on a front face of the conically configured projection surface elements 202, 203. A virtual viewing window 211 is generated for an observer, in particular the patient 15, using the image transmission unit 204 and the projection surface unit 201.

The image transmission unit 204 has a beam splitter unit 208. This allows images of different parts, which are captured for example using different image recording elements 210 of an image recording unit 209, to be transmitted specifically to and displayed in a visible manner on the two different conically configured projection surface elements 202, 203.

A further embodiment and/or mode of operation of the projection unit 200 is configured as in the description relating to the exemplary embodiment in FIGS. 2 to 4.

As an alternative to the proposed exemplary embodiments, the projection surface unit 31, 103, 155, 201 can also have at least one illumination unit and at least one projection surface element 38, 156, 202, 203. The illumination unit can comprise for example light-emitting diodes (LEDs), which are disposed at least partially around the projection surface element 38, 156, 202, 203, for example on end faces of the projection surface element 38, 156, 202, 203. The image transmission unit 41, 153, 204 can also comprise light guides, which transmit image beams to a projection surface element 38, 156, 202, 203.

While specific embodiments have been described in detail, those with ordinary skill in the art will appreciate that various modifications and alternative to those details could be developed in light of the overall teachings of the disclosure. For example, elements described in association with different embodiments may be combined. Accordingly, the particular arrangements disclosed are meant to be illustrative only and should not be construed as limiting the scope of the claims or disclosure, which are to be given the full breadth of the appended claims, and any and all equivalents thereof. It should be noted that the term “comprising” does not exclude other elements or steps and the use of articles “a” or “an” does not exclude a plurality.

1. A medical imaging apparatus, comprising:
a detector unit,
a housing unit enclosing the detector unit,
a cylindrical receiving region to receive a patient, the receiving region being enclosed in a cylindrical manner by the housing unit enclosing the detector unit, and
a projection unit,
wherein the projection unit has at least one projection surface unit, on which images of objects disposed outside the detector unit and the housing unit enclosing the detector unit are displayed to generate a virtual viewing window for an observer.

2. The medical imaging apparatus as claimed in claim 1, wherein the projection surface unit has at least one projection surface element, which is at least partially encompassed by the housing unit enclosing the detector unit.

3. The medical imaging apparatus as claimed in claim 2, wherein the at least one projection surface element is encompassed at least partially by the housing unit enclosing the receiving region.

4. The medical imaging apparatus as claimed in claim 1, wherein the projection surface unit has at least one projection surface element, which comprises a reflecting projection surface.

5. The medical imaging apparatus as claimed in claim 1, wherein the projection surface unit has at least one projection surface element, which is configured conically.

6. The medical imaging apparatus as claimed in claim 5, wherein the conically configured projection surface element is disposed within the receiving region, with an opening in the conically configured projection surface element facing the patient and/or an isocenter.

7. The medical imaging apparatus as claimed in claim 1, wherein the projection surface unit has at least one projection surface element, which comprises a flat screen.

8. The medical imaging apparatus as claimed in claim 1, wherein the projection surface unit has an at least partial strip-type lens coating.

9. The medical imaging apparatus as claimed in claim 1, wherein the projection unit has an image transmission unit, which is designed to project and/or transmit images onto the projection surface unit.

10. The medical imaging apparatus as claimed in claim 9,
wherein the image transmission unit is disposed at least partially outside the receiving region to display images within the receiving region.

11. The medical imaging apparatus as claimed in claim 9, wherein the image transmission unit has at least one cylindrical lens element.

12. The medical imaging apparatus as claimed in claim 1, wherein the projection unit has at least one image recording unit.

13. The medical imaging apparatus as claimed in claim 12, wherein the image recording unit has at least one image recording element, which comprises an optical wide-angle lens element.

14. The medical imaging apparatus as claimed in claim 13, wherein the optical wide-angle lens element is formed by a hypergon lens.

15. The medical imaging apparatus as claimed in claim 12, wherein the image recording unit is disposed at least partially on an outer face of the housing unit enclosing the detector unit.

16. The medical imaging apparatus as claimed in claim 12, wherein the image recording unit has at least one beam splitter unit.

17. The medical imaging apparatus as claimed in claim 1, wherein the projection unit has at least one digital data processing unit, which processes recordings from at least two image recording elements to produce a common projection image.

18. A method for projecting images of objects for a medical imaging apparatus as claimed in claim 1, wherein the objects are concealed by the detector unit of the medical imaging apparatus and the housing unit encloses the detector unit along a viewing direction of an observer, the method comprising:
projecting the image on a face of the detector unit facing the observer and/or on a face of the housing unit enclosing the detector unit facing the observer.

19. The method as claimed in claim 18, comprising displaying the image on a projection surface unit with little delay.

20. The method as claimed in claim 18, comprising displaying a sequence of a number of images at a speed of at least 25 images per second on a projection surface unit.

21. The method as claimed in claim 18, comprising performing an image calibration before a display on a projection surface.
